(19) United States
(12) Patent Application Publication
(10) Pub. No.: US 2009/0270108 A1
(43) Pub. Date: Oct. 29, 2009

(54) SYSTEMS AND METHODS FOR MEASURING CHANNEL QUALITY FOR PERSISTENT SCHEDULED USER EQUIPMENT

(75) Inventor: Shugong Xu, Vancouver, WA (US)

Correspondence Address: AUSTIN RAPP & HARDMAN, 170 SOUTH MAIN STREET, SUITE 735, SALT LAKE CITY, UT, 84101, US

(73) Assignee: Sharp Laboratories of America, Inc., Camas, WA (US)

(21) Appl. No.: 12/111,128

(22) Filed: Apr. 28, 2008

(51) Int. Cl. H04Q 7/20; H04Q 7/34

(52) U.S. Cl. 455/452.2

(57) ABSTRACT

A method for measuring the quality of a channel for persistent scheduled user equipment (UE) in a communications system is described. Frequency location information for at least one physical resource block (PRB) for a Physical Downlink Shared Channel (PDSCH) is received. The quality of a channel associated with at least one frequency sub-band of the frequency location information is measured. A channel quality indicator (CQI) corresponding to the measured channel quality is transmitted.

### TECHNICAL FIELD

The present disclosure relates generally to communications and wireless communications systems. More specifically, the present disclosure relates to systems and methods for measuring channel quality for persistent scheduled user equipment.

### BACKGROUND

The 3rd Generation Partnership Project, also referred to as “3GPP,” is a collaboration agreement that aims to define globally applicable Technical Specifications and Technical Reports for 3rd Generation Systems. 3GPP Long Term Evolution (LTE) is the name given to a project to improve the Universal Mobile Telecommunications System (UMTS) mobile phone or device standard to cope with future requirements. The 3GPP may define specifications for the next generation mobile networks, systems, and devices. In one aspect, UMTS has been modified to provide support and specification for the Evolved Universal Terrestrial Radio Access (E-UTRA) and Evolved Universal Terrestrial Radio Access Network (E-UTRAN). In 3GPP LTE (E-UTRA and E-UTRAN) terminology, a base station is called an “evolved NodeB” (eNB) and a mobile terminal or device is called a “user equipment” (UE).

In 3GPP LTE, the eNB regularly transmits a downlink reference symbol (DLRS) that is used by the UEs for channel measurement, such as signal-to-interference ratio (SINR), which may be represented by a channel quality indicator (CQI). Each UE regularly transmits CQIs back to the eNB to enable the eNB to perform resource scheduling. Resource scheduling means the eNB allocates the modulation schemes, coding rates and subcarrier frequencies to optimize the downlink and uplink transmissions for each UE.

The data transmitted over a wireless network may be categorized as either non-real-time (NRT) data or real-time (RT) data. Examples of NRT data include data transmitted during web browsing by a UE or text-messaging to a UE, while an example of RT data is voice communication between UEs. The typical manner of resource scheduling for NRT data is dynamic scheduling by the eNB to each UE at each transmission time interval (TTI). During dynamic scheduling, the UE regularly transmits CQIs back to the eNB.

However, in 3GPP LTE the UEs transmit and receive RT data, specifically voice data which may be carried as Voice over Internet Protocol (VoIP) transmissions. A typical VoIP session has periodic small data packets at fixed intervals and periodic silence indication (SID) packets at fixed intervals. Unlike NRT data transmission, VoIP transmission is handled using persistent scheduling. In contrast to dynamic scheduling, in persistent scheduling when a UE's downlink reception is enabled, if the UE cannot find its resource allocation, a downlink transmission according to a predefined resource allocation is assumed.

VoIP transmission and its associated persistent method of resource allocation present special issues regarding the transmission of CQIs by the UEs through an uplink control channel. As such, benefits may be realized by providing systems and methods for measuring channel quality for persistent scheduled user equipment.

### BRIEF DESCRIPTION OF THE DRAWINGS

FIG. 1 illustrates an exemplary wireless communication system in which configurations may be practiced;

FIG. 2 is a high-level block diagram of exemplary control protocol stacks of a base station, such as an evolved NodeB (eNB), and a user equipment (UE);

FIG. 3 is a block diagram of one configuration of the eNB and the UE;

FIG. 4 is a flow diagram illustrating one example of a method for measuring channel quality for a persistent scheduled device;

FIG. 5 is a flow diagram illustrating one example of a method for scheduling resources for a device;

FIG. 6 is a thread diagram illustrating one example of persistent scheduling communication in accordance with the present systems and methods;

FIG. 7 illustrates various components that may be utilized in a communications device; and

FIG. 8 illustrates various components that may be utilized in a base station.

### DETAILED DESCRIPTION

In a communications system, measurement reports may be sent from a first device to a second device. Measurement reports may indicate the quality of the environment of the communication system. Communications from the first device to the second device may be referred to as uplink communications. Similarly, communications from the second device to the first device may be referred to as downlink communications.

The second device may be a base station, an evolved NodeB (eNB), etc. The first device may be a mobile station, user equipment (UE), etc. In one example, the reports include measurements of the UE's radio environment. The eNB may use the report (which indicates channel state information) for scheduling and link adaptation. In one example, the measurement report is used by the eNB to exploit frequency diversity by means of frequency domain scheduling in long-term evolution (LTE) communication systems.

In one example, the measurement reports indicate the quality of a channel used for communications on the uplink or downlink. As such, a measurement report may be sent as a channel quality indicator (CQI). In one configuration, measurement reports may be utilized to enable the second device to operate in both uplink and downlink communications.

If the CQI information is accurate, the scheduling of resources conducted by the eNB is improved. In order for the UE to supply accurate CQI information to the eNB, a UE may measure the radio environment at the correct time and at the correct frequency band. In one configuration, the transmission bit rate in uplink communications (i.e., from the UE to the eNB) may be limited for control signaling (e.g., CQI information). As a result, the full channel state information may not be transmitted by each UE within a communications system.

In one example, E-UTRA supports various types of CQI reporting. For example, E-UTRA may support wideband CQI reporting which provides channel quality information of the entire bandwidth of a communications system. As another example, E-UTRA may support a UE selected multi-band type of CQI reporting. The UE selected multi-band type may provide channel quality information of a subset(s) of the bandwidth of the communication system. In one configuration, the subset(s) may be determined by the UE. Further, E-UTRA may support eNB configured multi-band type of CQI reporting. The eNB configured multi-band type may provide channel quality information of a subset(s) of the bandwidth of the communication system. However, in contrast to the UE selected multi-band type, the subset(s) may be configured by the eNB (i.e., base station).

In existing 3GPP art, CQI reporting for Voice over Internet Protocol (VoIP) is assumed to be wideband CQI reporting (i.e., channel condition for the entire bandwidth of the system is reported). Such wideband CQI reporting may provide very coarse channel quality information over a large bandwidth. The eNB may not be enabled to accurately schedule resources for the UE based on such coarse channel quality information.

Data may be allocated to the UEs in terms of resource blocks. Resource blocks are used to describe the mapping of certain physical channels to resource elements. Physical resource blocks and virtual resource blocks are defined.

A physical resource block is defined as a certain number of consecutive orthogonal frequency division multiplexing (OFDM) symbols in the time domain and a certain number of consecutive subcarriers in the frequency domain.

A virtual resource block is of the same size as a physical resource block. Two types of virtual resource blocks are defined: virtual resource blocks of localized type, and virtual resource blocks of distributed type.

Virtual resource blocks of localized type are mapped directly to physical resource blocks such that virtual resource block n_{VRB} corresponds to physical resource block n_{PRB}=n_{VRB}.

Virtual resource blocks of distributed type are mapped to physical resource blocks such that virtual resource block n_{VRB} corresponds to physical resource block n_{PRB}=f(n_{VRB},nₛ), where nₛ is the slot number within a radio frame. The virtual-to-physical resource block mapping is different in the two slots of a subframe.

In one example, the UE typically utilizes a small portion of the system bandwidth (for example two physical resource blocks (PRBs) out of a hundred PRBs for a system bandwidth of 20 Megahertz (MHz)). As such, the CQI over the entire bandwidth may not provide the channel quality to the eNB of the particular PRB associated with the UE. Degraded system performance may result if a scheduler (e.g., the eNB) decides modulation and coding schemes (MCS) for a particular PRB using wideband CQI reporting techniques.

However, VoIP transmission may be typically handled using semi-persistent scheduling. The semi-persistent scheduling may be configured by Radio Resource Control (RRC) signaling on an allocated PRB. In other words, the actual frequency location of the PRB (or PRBs) for the persistent (or semi-persistent) scheduled UE may be known. The phrase “persistent scheduled UE” may represent either a persistent scheduled UE or a semi-persistent scheduled UE. In addition, the timing of such downlink transmissions may also be known. As such, benefits may be realized by providing systems and methods to allow a UE to utilize the known location information of the persistently scheduled PRB in order to provide more accurate and useful CQI information to an eNB.

A method for measuring the quality of a channel for persistent scheduled user equipment (UE) in a communications system is described. Frequency location information for at least one physical resource block (PRB) for a Physical Downlink Shared Channel (PDSCH) is received. The quality of a channel associated with at least one frequency sub-band of the frequency location information is measured. A channel quality indicator (CQI) corresponding to the measured channel quality is transmitted.

In one example, the CQI includes an average of the quality of the channel associated with at least two frequency sub-bands of the frequency location information. In one configuration, the measured CQI may be transmitted as a wide-band CQI. The resources for the PDSCH may be received via Radio Resource Control (RRC) signaling. In another configuration, the resources for the PDSCH may be received via a Physical Downlink Control Channel (PDCCH).

A persistent scheduled communications device that is configured to measure the quality of a channel in a communications system is also described. The communications device includes a resource receiver configured to receive frequency location information for at least one physical resource block (PRB) for a Physical Downlink Shared Channel (PDSCH). The communications device also includes a frequency sub-band controller configured to measure the quality of a channel associated with at least one frequency sub-band of the frequency location information. The communications device further includes a transmitter configured to transmit a channel quality indicator (CQI) corresponding to the measured channel quality.

A computer-readable medium comprising executable instructions is also described. The instructions are executable for receiving frequency location information for at least one physical resource block (PRB) for a Physical Downlink Shared Channel (PDSCH). The instructions are also executable for measuring the quality of a channel associated with at least one frequency sub-band of the frequency location information. The instructions are further executable for transmitting a channel quality indicator (CQI) corresponding to the measured channel quality.

A persistent scheduled communications device that is also configured to measure the quality of a channel in a communications system is further described. The communications device includes means for receiving frequency location information for at least one physical resource block (PRB) for a Physical Downlink Shared Channel (PDSCH). The communications device also includes means for measuring the quality of a channel associated with at least one frequency sub-band of the frequency location information. The communications device further includes means for transmitting a channel quality indicator (CQI) corresponding to the measured channel quality.

A base station configured to allocate resources to a persistent scheduled communications device is also described. The base station includes a resource block location controller configured to send frequency location information for at least one physical resource block (PRB) to the persistent scheduled communications device. The base station also includes a resource controller configured to receive a channel quality indicator corresponding to the quality of a channel associated with at least one frequency sub-band of the frequency location information. The base station further includes a scheduler configured to schedule resources based on the received channel quality indicator.

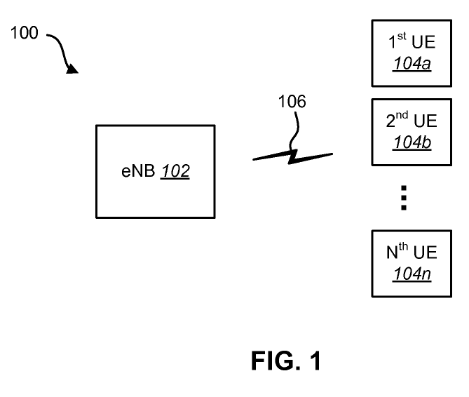

FIG. 1 illustrates an exemplary wireless communication system 100 in which examples may be practiced. An Evolved NodeB (eNB) 102 is in wireless communication with one or more pieces of mobile user equipment (UE) 104 (which may also be referred to as mobile stations, user devices, communications devices, subscriber units, access terminals, terminals, etc.). The eNB 102 may also be referred to as a base station. The eNB 102 may be a unit adapted to transmit to and receive data from cells. In one example, the eNB 102 handles the actual communication across a radio interface, covering a specific geographical area, also referred to as a cell. Depending on sectoring, one or more cells may be served by the eNB 102, and accordingly the eNB 102 may support one or more mobile UEs 104 depending on where the UEs are located. In one configuration, the eNB 102 provides a Long Term Evolution (LTE) air interface and performs radio resource management for the communication system 100.

A first UE 104a, a second UE 104b, and an Nth UE 104n are shown in FIG. 1. The eNB 102 transmits data to the UEs 104 over a radio frequency (RF) communication channel 106. The transmitted data may include a plurality of LTE frames. Each of the LTE radio frames may have a length of 10 ms.

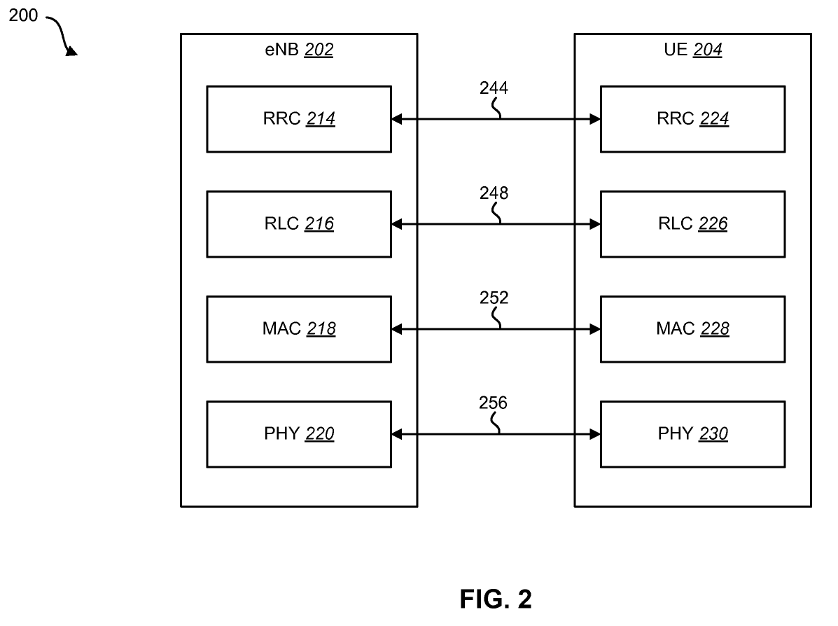

FIG. 2 is an exemplary diagram 200 of a portion of the protocol stacks for the control plane of a UE 204 and an eNB 202. The exemplary protocol stacks provide radio interface architecture between the eNB 202 and the UE 204. In one configuration, the control plane includes a Layer 1 stack that includes a physical (PHY) layer 220, 230, a Layer 2 stack that includes a medium access control (MAC) layer 218, 228, and a Radio Link Control (RLC) layer 216, 226, and a Layer 3 stack that includes a Radio Resource Control (RRC) layer 214, 224.

The RRC layer 214, 224 is generally a Layer 3 radio interface adapted to provide an information transfer service to the non-access stratum. The RRC layer 214, 224 of the present systems and methods may transfer Channel Quality Indicator (CQI) information and Acknowledgement/Non-Acknowledgment (ACK/NAK) information from the UE 204 to the eNB 202. The RRC layer 214, 224 may also provide RRC connection management.

The RLC layer 216, 226 is a Layer 2 radio interface adapted to provide transparent, unacknowledged, and acknowledged data transfer service. The MAC layer 218, 228 is a radio interface layer providing unacknowledged data transfer service on the logical channels and access to transport channels. The MAC layer 218, 228 may be adapted to provide mappings between logical channels and transport channels.

The PHY layer 220, 230 generally provides information transfer services to the MAC layer 218, 228 and other higher layers 216, 214, 226, 224. Typically the PHY layer 220, 230 transport services are described by their manner of transport. Furthermore, the PHY layer 220, 230 may be adapted to provide multiple control channels. In one example, the UE 204 is adapted to monitor this set of control channels. Furthermore, as shown, each layer communicates with its compatible layer 244, 248, 252, 256.

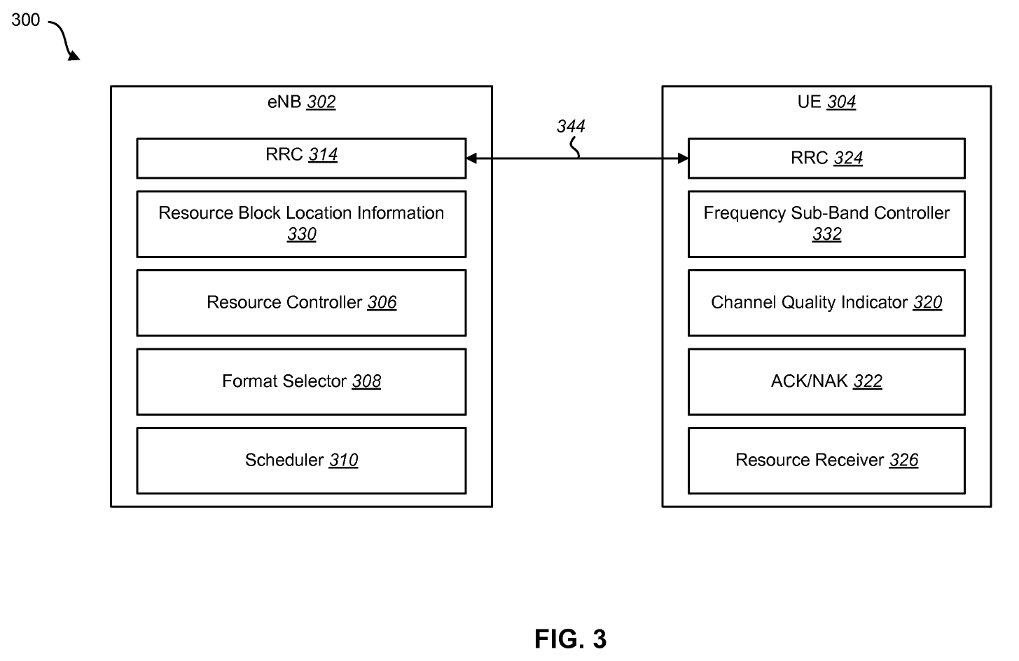

FIG. 3 is a block diagram 300 illustrating one configuration of the eNB 302 and the UE 304. The eNB 302 may include a resource controller 306 that allocates resources to the UE 304. The UE 304 may utilize these resources to send information to and receive information from the eNB 302. In one configuration, the resource controller 306 allocates resources for a Physical Downlink Shared Channel (PDSCH) and a Physical Uplink Shared Channel (PUSCH). In addition, the resource controller 306 may allocate resources for a Physical Hybrid Automatic Request Indicator Channel (PHICH). The PHICH may be utilized to carry ACK/NAK information on a downlink (i.e., from the eNB 302 to the UE 304). Further, the controller 306 may also allocate resources for a Physical Uplink Control Channel (PUCCH). The PUCCH may be utilized to carry ACK/NAK information 322 and CQI information 320 from the UE 304 to the eNB 302 on an uplink.

In one configuration, the allocation of resources for the PUCCH may include information regarding the time and frequency associated with the PUCCH. The allocation of the PUCCH may also include information regarding a UE index. Further, the allocation of the PUCCH may indicate to the UE 304 which format of the PUCCH is to be utilized. A format selector 308 may be used to select the format type of the PUCCH. In one example, the PUCCH includes three format types (e.g., format 0, format 1 and format 2).

The eNB 302 may also include a scheduler 310 that schedules information received from the UE 304 into one or more subframes of the LTE radio frames. In one configuration, the scheduler 310 allocates different subframes for CQI information 320 and ACK/NAK information 322 received from the UE 304.

In one configuration, the eNB 302 may also include resource block location information 330. The location information 330 may be transmitted to the UE 304. In one example, the resource block location information 330 indicates the location of a PRB(s) where, in the frequency domain, the UE 304 should receive and decode a downlink data transmission sent from the eNB 302.

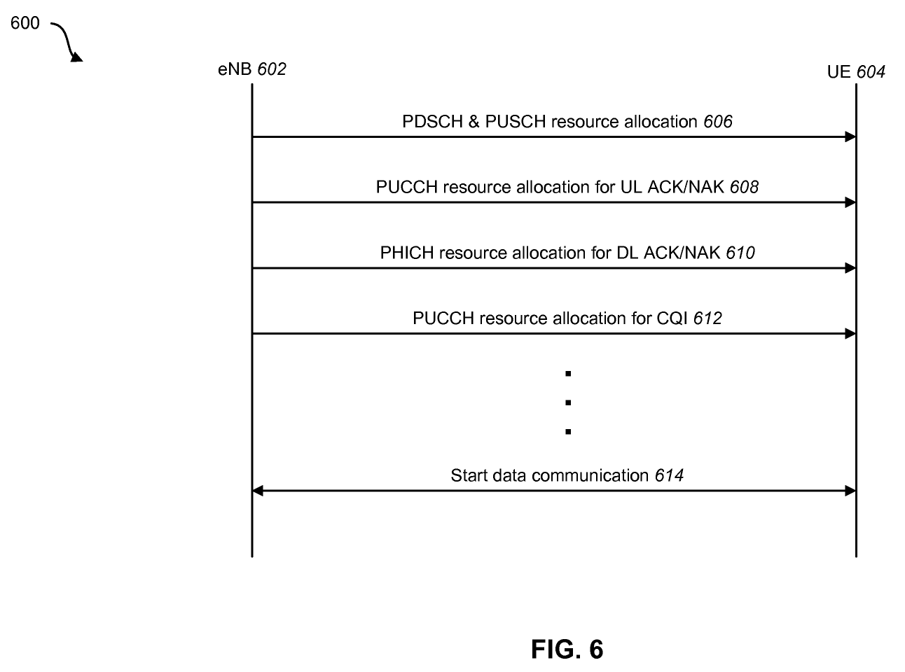

For a downlink persistent (or semi-persistent) scheduled UE, such as the UE 304, there may be a need to signal resource allocation on the PDSCH to the UE 304. In one example, a possible signaling mechanism for the allocation of resources includes the implementation of RRC signaling. A second possible signaling mechanism includes the use of a Physical Downlink Control Channel (PDCCH) to carry the control signals. In one configuration, RRC may be layer 3 control signaling as previously described. More details regarding RRC control signaling will be discussed below in relation to FIG. 6.

In one configuration, the UE 304 may be enabled to determine whether PDSCH resource allocation is persistent or not. For example, if PDCCH is used for the allocation of resources, there may be RRC signaling to indicate to the UE 304 the periodicity of the persistent scheduling, while the exact location of the PRB (or PRBs) may be carried by the PDCCH. In other words, for either RRC signaling or PDCCH signaling, the UE 304 may have knowledge of the PDSCH resource allocation (i.e., the PRB(s) location, where in the frequency domain, the UE 304 should receive and decode the downlink data transmissions from the eNB 302).

The UE 304 may include a resource receiver 326 that receives the allocation of resources from the eNB 302. The receiver 326 may also determine the format type of the PUCCH. The UE 304 may transmit CQI information 320 or ACK/NAK information 322 on the PUCCH. The UE 304 includes the RRC layer 324 and may communicate with the eNB 302 through RRC signaling 344 with the corresponding RRC layer 314 of the eNB 302.

The UE 304 may also include a frequency sub-band controller 332. The controller 332 may utilize the location information 330 received from the eNB 302 regarding the location of the PRB(s) to measure channel quality associated with that particular PRB(s). More details describing the location information 330 and the frequency sub-band controller 332 are provided below.

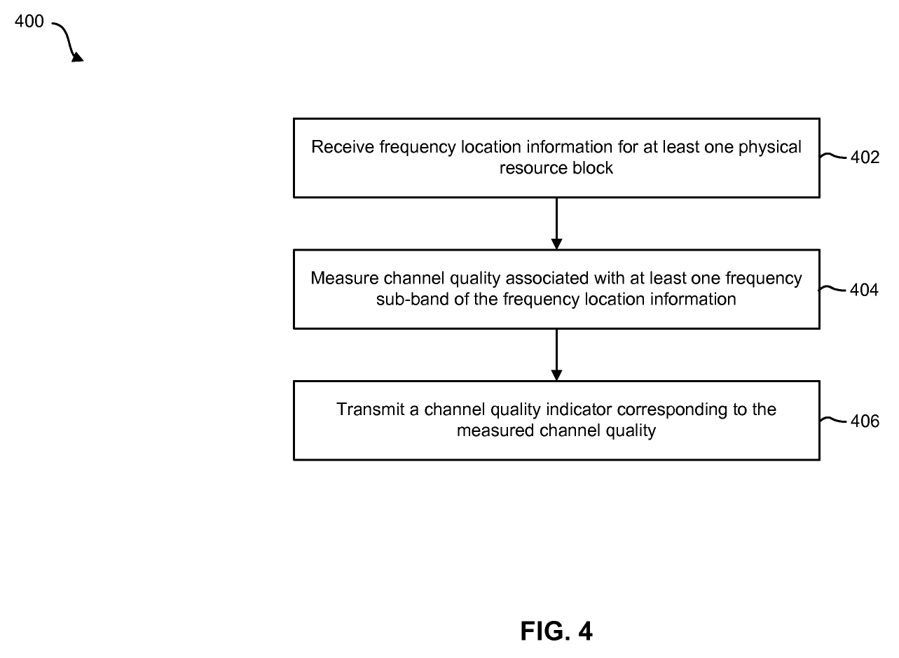

FIG. 4 is a flow diagram illustrating one example of a method 400 for measuring channel quality for a persistent scheduled device. In one configuration, the device may be a UE in an LTE communications system. The method 400 may be implemented by the UE 304. In particular, the method 400 may be implemented by the frequency sub-band controller 332 previously described.

In one configuration, frequency location information for at least one physical resource block (PRB) may be received 402. In one configuration, channel quality associated with at least one frequency sub-band of the frequency location information is measured 404. For example, a persistent scheduled UE may utilize PRB location information received via a signaling technique (RRC or PDCCH) to measure 404 the channel quality on the persistent scheduled PRB (or PRBs). As previously mentioned, such PRB location information may be signaled via RRC or PDCCH, which may be part of the persistent resource allocation on PDSCH.

The UE may utilize the frequency domain location of the assigned PRB(s) to decide which sub-band(s) should be measured 404 for channel quality. In one configuration, a persistent scheduled UE may report the measured channel quality information on one or more sub-bands using the UE selected multi-band reporting technique previously described. In contrast to the Node B configured multi-band reporting technique, there may not be a need for additional RRC signaling if the UE selected multi-band reporting is implemented.

In another configuration, the UE may report the average of the measured sub-bands' channel quality information. In one example, the average may be reported as one representation of wide-band CQI. Such representation of the wide-band CQI may be more accurate and useful for the UE than the average over the entire bandwidth of the communications system. The average of the measured sub-bands' channel quality information may be referred to as optimized wide-band CQI.

A channel quality indicator (CQI) corresponding to the measured channel quality may be transmitted 406. In one configuration, the measured channel quality may be transmitted 406 to the eNB 302. If the UE uses the PUCCH to transmit 406 the CQI, the optimized wide-band CQI information may be carried using either two bits or four bits. Alternatively, the CQI information may be transmitted 406 to the eNB using the PUSCH if there is PUSCH resources allocated in the particular transmission time interval (TTI).

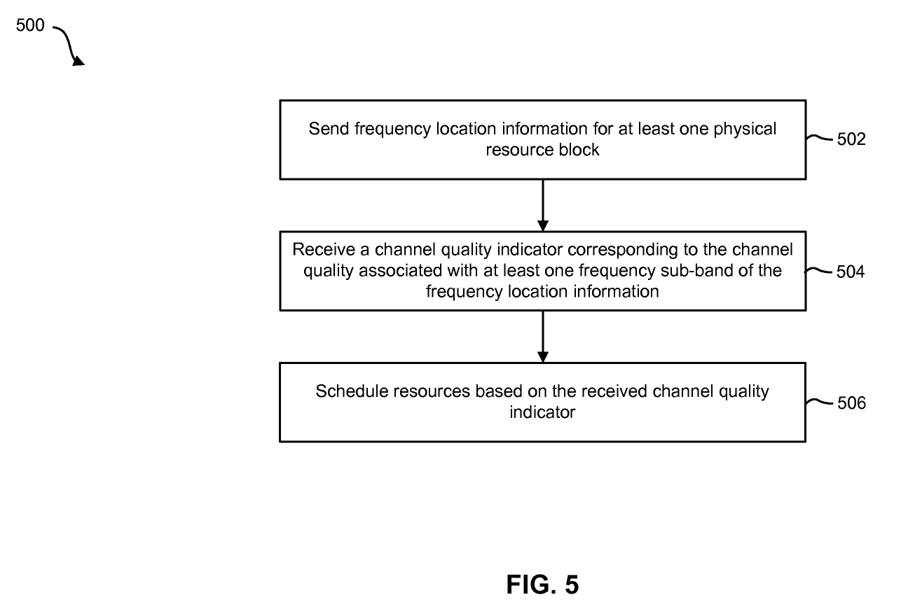

FIG. 5 is a flow diagram illustrating one example of a method 500 for scheduling resources for a UE. The method 500 may be implemented by the eNB 302. In one configuration, frequency location information for at least one physical resource block (PRB) may be sent 502. The frequency location information may indicate the frequency domain of the PRB. A channel quality indicator (CQI) is received 504. The CQI may indicate the quality of a channel associated with at least one frequency sub-band of the frequency location information. In addition, resources based on the received CQI may be scheduled 506 for the UE 304.

FIG. 6 is a thread diagram 600 illustrating one configuration of persistent scheduling communication in accordance with the present systems and methods. In one configuration, before data communication is started 614, the eNB 602 informs the allocation of resources to the UE 604 via RRC signaling 344. For example, the resources for the PDSCH and the PUSCH may be allocated 606 to the UE 604. In addition, the resources for UL ACK/NAK on the PUCCH may also be allocated 608. The eNB 602 may further allocate 610 resources for DL ACK/NAK. The DL ACK/NAK may be carried on the PHICH. Further, resources may be allocated 612 for CQI information that is carried on the PUCCH. Additional resources may be allocated that are not shown in FIG. 6.

Once the resources have been allocated, data communications may start 614 between the eNB 602 to the UE 604. The UE 604 may be a persistent scheduled UE. In one configuration, the PUCCH resource allocation 608, 612 may include the time and frequency of the PUCCH. In addition, the resource allocation 608, 612 may include the format type (i.e., format 0, format 1 or format 2) of the PUCCH. In another configuration, the eNB 602 may communicate with a dynamic scheduled UE and a persistent scheduled UE at the same time based on a configuration provided from RRC signaling 344.

As shown in FIG. 6, the eNB 602 may provide the resource allocation parameters for the PUCCH to each persistent scheduled UE. However, for dynamic scheduling, the eNB 602 may reserve a set of allocation parameters for dynamic scheduled UEs. Otherwise, resources for a dynamic scheduled UE and a persistent scheduled UE may conflict.

The present systems and methods may be implemented in application that utilize persistent (or semi-persistent) scheduled UEs, such as VoIP, on-line gaming, etc. If the UE transmits and/or receives other types of traffic, the UE may utilize dynamic scheduled resource allocation. The present systems and methods described herein relate to 3GPP LTE systems. However, the present systems and methods may be utilized for other OFDM communication systems, for example IEEE 802.16m.

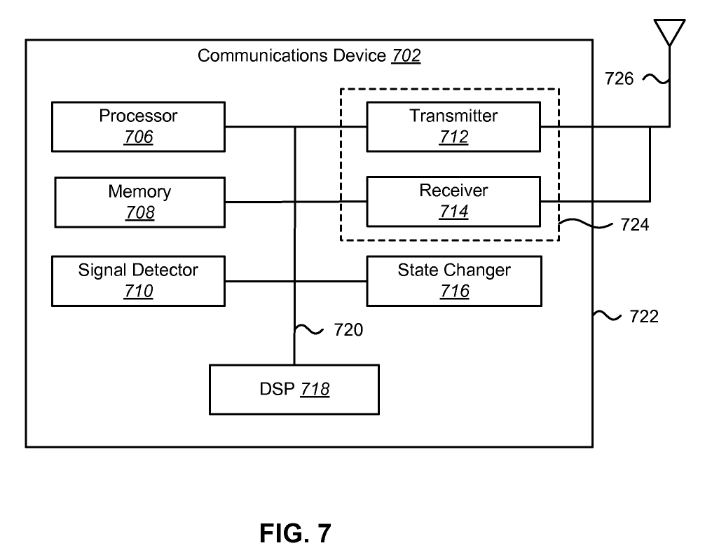

FIG. 7 illustrates various components that may be utilized in a communications device 702, such as a UE, in accordance with one configuration. The device 702 includes a processor 706 which controls operation of the device 702. The processor 706 may also be referred to as a CPU.

Memory 708, which may include both read-only memory (ROM) and random access memory (RAM), provides instructions and data to the processor 706. A portion of the memory 708 may also include non-volatile random access memory (NVRAM). The memory 708 may include any electronic component capable of storing electronic information, and may be embodied as ROM, RAM, magnetic disk storage media, optical storage media, flash memory, on-board memory included with the processor 706, EPROM memory, EEPROM memory, registers, a hard disk, a removable disk, a CD-ROM, etc. The memory 708 may store program instructions and other types of data. The program instructions may be executed by the processor 706 to implement some or all of the methods disclosed herein.

The device 702 may also include a housing 722 that includes a transmitter 712 and a receiver 714 to allow transmission and reception of data between the communications device 702 and a remote location. The transmitter 712 and receiver 714 may be combined into a transceiver 724. An antenna 726 is attached to the housing 722 and electrically coupled to the transceiver 724.

The communications device 702 also includes a signal detector 710 used to detect and quantify the level of signals received by the transceiver 724. The signal detector 710 detects such signals as total energy, power spectral density and other signals.

A state changer 716 of the device 702 controls the state of the device 702 based on a current state and additional signals received by the transceiver 724 and detected by the signal detector 710. The device 702 is capable of operating in any one of a number of states.

The various components of the device 702 are coupled together by a bus system 720 which may include a power bus, a control signal bus, and a status signal bus in addition to a data bus. However, for the sake of clarity, the various busses are illustrated in FIG. 7 as the bus system 720. The device 702 may also include a digital signal processor (DSP) 718 for use in processing signals.

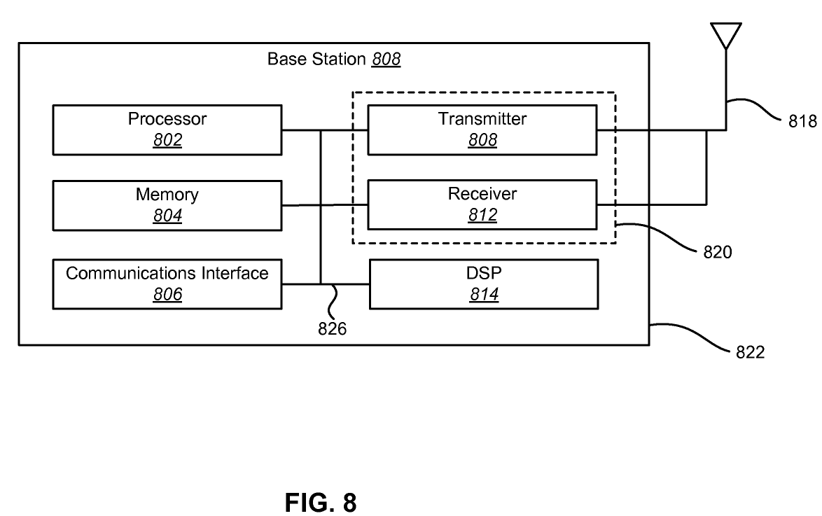

FIG. 8 is a block diagram of a base station 808 in accordance with one configuration of the described systems and methods. The base station 808 may be an eNB, a base station controller, a base station transceiver, etc. The base station 808 includes a transceiver 820 that includes a transmitter 810 and a receiver 812. The transceiver 820 may be coupled to an antenna 818. The base station 808 further includes a digital signal processor (DSP) 814, a general purpose processor 802, memory 804, and a communication interface 806. The various components of the base station 808 may be included within a housing 822.

The processor 802 may control operation of the base station 808. The processor 802 may also be referred to as a CPU. The memory 804, which may include both read-only memory (ROM) and random access memory (RAM), provides instructions and data to the processor 802. A portion of the memory 804 may also include non-volatile random access memory (NVRAM). The memory 804 may include any electronic component capable of storing electronic information, and may be embodied as ROM, RAM, magnetic disk storage media, optical storage media, flash memory, on-board memory included with the processor 802, EPROM memory, EEPROM memory, registers, a hard disk, a removable disk, a CD-ROM, etc. The memory 804 may store program instructions and other types of data. The program instructions may be executed by the processor 802 to implement some or all of the methods disclosed herein.

In accordance with the disclosed systems and methods, the antenna 818 may receive reverse link signals that have been transmitted from a nearby communications device 702, such as a UE. The antenna 818 provides these received signals to the transceiver 820 which filters and amplifies the signals. The signals are provided from the transceiver 820 to the DSP 814 and to the general purpose processor 802 for demodulation, decoding, further filtering, etc.

The various components of the base station 808 are coupled together by a bus system 826 which may include a power bus, a control signal bus, and a status signal bus in addition to a data bus. However, for the sake of clarity, the various busses are illustrated in FIG. 8 as the bus system 826.

As used herein, the term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The various illustrative logical blocks, modules and circuits described herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described herein may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM and so forth. A software module may comprise a single instruction, or many instructions, and may be distributed over several different code segments, among different programs and across multiple storage media. An exemplary storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A computer-readable medium may be any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Functions such as executing, processing, performing, running, determining, notifying, sending, receiving, storing, requesting, and/or other functions may include performing the function using a web service. Web services may include software systems designed to support interoperable machine-to-machine interaction over a computer network, such as the Internet. Web services may include various protocols and standards that may be used to exchange data between applications or systems. For example, the web services may include messaging specifications, security specifications, reliable messaging specifications, transaction specifications, metadata specifications, XML specifications, management specifications, and/or business process specifications. Commonly used specifications like SOAP, WSDL, XML, and/or other specifications may be used.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for measuring the quality of a channel for persistent scheduled user equipment (UE) in a communications system, comprising:
receiving frequency location information for at least one physical resource block (PRB) for a Physical Downlink Shared Channel (PDSCH);
measuring the quality of a channel associated with at least one frequency sub-band of the frequency location information; and
transmitting a channel quality indicator (CQI) corresponding to the measured channel quality.

2. The method of claim 1, wherein the CQI comprises an average of the quality of the channel associated with at least two frequency sub-bands of the frequency location information.

3. The method of claim 2, further comprising transmitting the measured CQI as a wide-band CQI.

4. The method of claim 1, further comprising receiving the resources for the PDSCH via Radio Resource Control (RRC) signaling.

5. The method of claim 1, further comprising receiving the resources for the PDSCH via a Physical Downlink Control Channel (PDCCH).

6. A persistent scheduled communications device that is configured to measure the quality of a channel in a communications system, the communications device comprising:
a resource receiver configured to receive frequency location information for at least one physical resource block (PRB) for a Physical Downlink Shared Channel (PDSCH);
a frequency sub-band controller configured to measure the quality of a channel associated with at least one frequency sub-band of the frequency location information; and
a transmitter configured to transmit a channel quality indicator (CQI) corresponding to the measured channel quality.

7. The communications device of claim 6, wherein the CQI comprises an average of the quality of the channel associated with at least two frequency sub-bands of the frequency location information.

8. The communications device of claim 7, wherein the transmitter is configured to transmit the CQI as a wide-band CQI.

9. The communications device of claim 6, wherein the resource receiver is further configured to receive resources for the PDSCH via Radio Resource Control (RRC) signaling.

10. The communications device of claim 6, wherein the resource receiver is further configured to receive resources for the PDSCH via a Physical Downlink Control Channel (PDCCH).

11. A computer-readable medium comprising executable instructions for:
receiving frequency location information for at least one physical resource block (PRB) for a Physical Downlink Shared Channel (PDSCH);
measuring the quality of a channel associated with at least one frequency sub-band of the frequency location information; and
transmitting a channel quality indicator (CQI) corresponding to the measured channel quality.

12. The computer-readable medium of claim 11, wherein the CQI comprises an average of the quality of the channel associated with at least two frequency sub-bands of the frequency location information.

13. The computer-readable medium of claim 12, wherein the instructions are further executable for transmitting the CQI as a wide-band CQI.

14. The computer-readable medium of claim 11, wherein the instructions are further executable for receiving the resources for the PDSCH via Radio Resource Control (RRC) signaling.

15. The computer-readable medium of claim 11, wherein the instructions are further executable for receiving the resources for the PDSCH via a Physical Downlink Control Channel (PDCCH).

16. A persistent scheduled communications device that is configured to measure the quality of a channel in a communications system, the communications device comprising:
means for receiving frequency location information for at least one physical resource block (PRB) for a Physical Downlink Shared Channel (PDSCH);
means for measuring the quality of a channel associated with at least one frequency sub-band of the frequency location information; and
means for transmitting a channel quality indicator (CQI) corresponding to the measured channel quality.

17. The communications device of claim 16, wherein the CQI comprises an average of the quality of the channel associated with at least two frequency sub-bands of the frequency location information.

18. The communications device of claim 17, further comprising means for transmitting the measured CQI as a wide-band CQI.

19. The communications device of claim 16, further comprising means for receiving the resources for the PDSCH via Radio Resource Control (RRC) signaling.

20. A base station configured to allocate resources to a persistent scheduled communications device, the base station comprising:
a resource block location controller configured to send frequency location information for at least one physical resource block (PRB) to the persistent scheduled communications device;
a resource controller configured to receive a channel quality indicator corresponding to the quality of a channel associated with at least one frequency sub-band of the frequency location information; and
a scheduler configured to schedule resources based on the received channel quality indicator.
